(19) United States
(12) Patent Application Publication
(10) Pub. No.: US 2013/0336010 A1
(43) Pub. Date: Dec. 19, 2013

(54) SYSTEMS AND METHODS FOR OPERATING AN AC/DC CONVERTER WHILE MAINTAINING HARMONIC DISTORTION LIMITS

(71) Applicants: Sunit Kumar Saxena, Bangalore (IN); Deepak Bhimrao Mahajan, Bangalore (IN)

(72) Inventors: Sunit Kumar Saxena, Bangalore (IN); Deepak Bhimrao Mahajan, Bangalore (IN)

(73) Assignee: HONEYWELL INTERNATIONAL INC., Morristown, NJ (US)

(21) Appl. No.: 13/525,819

(22) Filed: Jun. 18, 2012

(51) Int. Cl. H02M 7/02

(52) U.S. Cl. 363/13

(57) ABSTRACT

Alternating current to direct current (AC/DC) converter control systems and methods are operable to source high values of DC loads or source low values of DC loads while maintaining harmonic distortion limits. An exemplary embodiment receives direct current (DC) load information corresponding to a DC load drawn from an alternating current (AC) network by an AC/DC converter, wherein the AC network also sources a plurality of AC loads, and wherein harmonics output from the AC/DC converter is limited to at least a specified harmonic distortion limit; compares the DC load information with a load threshold; in response to the DC load information being at least equal to the load threshold, operates the AC/DC converter under continuous conduction mode (CCM) control; and in response to the DC load information being less than the load threshold, operates the AC/DC converter under critical conduction mode (CRM) control.

### BACKGROUND OF THE INVENTION

Use of direct-current (DC) powered electronic devices may result in an injection of current harmonics on alternating-current (AC) power supply networks when such DC electronic devices are sourced by an AC/DC converter sourced from the AC power supply network. To maintain the quality of AC power supplied to other devices sourced on the AC power supply network, various standards have been created to set levels for permissible levels of harmonic currents injected by DC loads back on to the AC power supply network. More particularly, Aerospace applications specify harmonics distortion limitations for any AC equipment so as to ensure safe and reliable operation of such AC equipment while an installation aircraft is in flight.

Advances in light emitting diode (LED) technology has permitted increasing use of LEDs in aircraft. For example, LEDs are now able to replace conventional lamps used in aircraft cabin sign lights, aircraft wing/tail warning lights and aircraft landing lights. Due to the large luminance requirements for LEDs used in the aircraft landing lights, the aircraft LED landing lights will draw a relatively large amount of DC current (compared to other DC devices, such as LEDs used in the LED cabin sign lights or the wing/tail warning lights). Because of the relatively large difference between the DC current used when only the LED cabin sign lights and/or the LED wing/tail warning lights are on, and when the LED landing lights are on, sourcing the LED cabin sign lights, the LED landing lights and the LED wing/tail warning lights using a single AC/DC converter may not be feasible because of induced harmonics from the single AC/DC converter which must provide relatively low amounts of DC current (when the LED landing lights are off) and relatively high amounts of DC current (when the LED landing lights are on). Accordingly, two AC/DC converters may be required; a first AC/DC converter to source the LED cabin sign lights and/or the LED wing/tail warning lights, and a second AC/DC converter to source the LED landing lights.

However, for aerospace applications where volume, weight and cost are critical requirements, it may not be desirable to use two separate AC/DC converters in an aircraft to separately source the LED cabin sign lights, the LED landing lights and the LED wing/tail warning lights. Thus, there is a need in the arts for a low-harmonic single AC/DC converter that is optimally designed for operation at rated power when the LED cabin sign lights, the LED landing lights and the LED wing/tail warning lights are used, and is further optimally designed for operation at low load conditions when the LED landing lights are not used.

### SUMMARY OF THE INVENTION

Alternating current to direct current (AC/DC) converter control systems and methods are disclosed that are operable to source high values of DC loads or source low values of DC loads while maintaining harmonic distortion limits. An exemplary embodiment receives direct current (DC) load information corresponding to a DC load drawn from an alternating current (AC) network by an AC/DC converter, wherein the AC network also sources a plurality of AC loads, and wherein harmonics output from the AC/DC converter is limited to at least a specified harmonic distortion limit; compares the DC load information with a load threshold; in response to the DC load information being at least equal to the load threshold, operates the AC/DC converter under continuous conduction mode (CCM) control; and in response to the DC load information being less than the load threshold, operates the AC/DC converter under critical conduction mode (CRM) control.

### BRIEF DESCRIPTION OF THE DRAWINGS

Preferred and alternative embodiments are described in detail below with reference to the following drawings:

FIG. 1 is a block diagram of an embodiment of the mode controlled AC/DC converter in an installation aircraft;

FIG. 2 is a block diagram of an embodiment of a mode controlled AC/DC converter;

FIG. 3 is a block diagram of an exemplary embodiment of the mode controlled AC/DC converter;

FIG. 4 is a block diagram of a firmware embodiment of the controller that provides hysteresis control; and

FIG. 5 is a block diagram of a software embodiment of the controller that provides hysteresis control.

### DETAILED DESCRIPTION OF THE PREFERRED EMBODIMENT

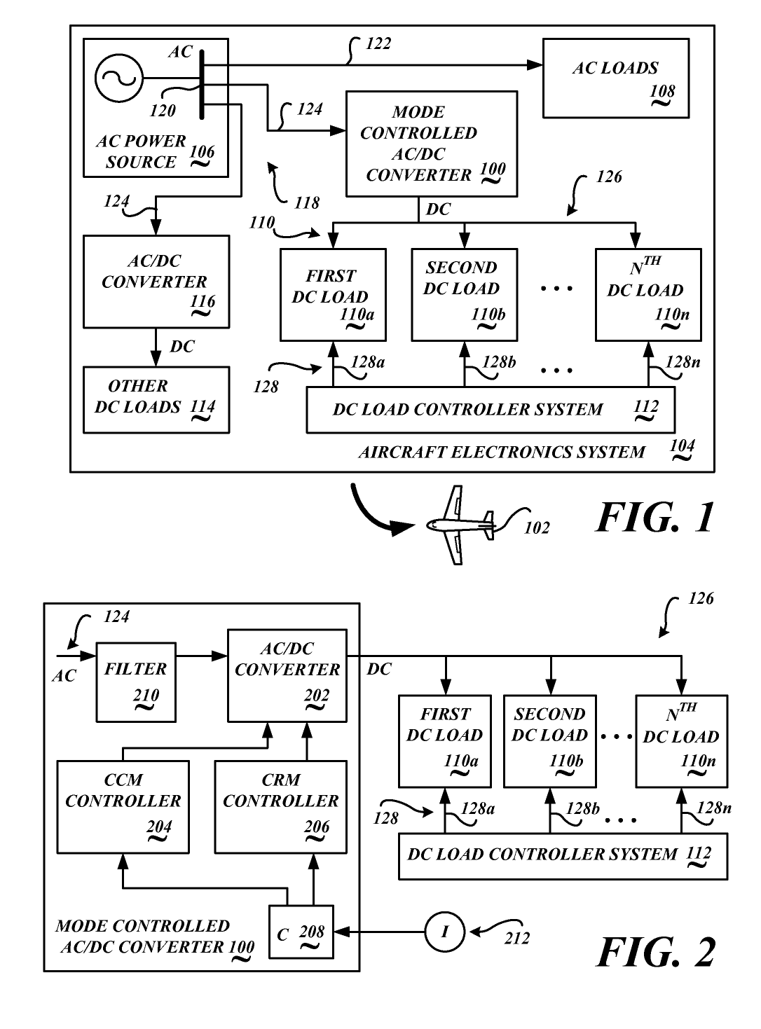

FIG. 1 is a block diagram of an embodiment of the mode controlled alternating current to direct current (AC/DC) converter 100 in an installation aircraft 102. An exemplary embodiment of mode controlled AC/DC converter 100 is operable to provide DC current substantially free of harmonic distortion, or to provide at least DC current at levels which satisfy a specified harmonic distortion limit, when the mode controlled AC/DC converter 100 is operated at low power or is operated at rated load (high power).

A comparison of DC loading information (corresponding to a DC load level on the mode controlled AC/DC converter 100) with a load threshold is made. When the mode controlled AC/DC converter 100 is operating at a DC load level that is greater than the load threshold, the mode controlled AC/DC converter 100 is operated under continuous conduction mode (CCM) control. When the mode controlled AC/DC converter 100 is operating at a DC load level that is less than the load threshold, the mode controlled AC/DC converter 100 is operated under critical conduction mode (CRM) control.

The simplified aircraft electronics system 104 includes an AC power source 106, AC loads 108, an embodiment of the mode controlled AC/DC converter 100, a plurality of DC loads 110, and a DC load controller system 112. In some situations, the aircraft electronics system 104 may further include other DC loads 114 optionally sourced by a AC/DC converter 116. DC loads 110 is a generic term identifying any type of load that draws DC power. For example, but not limited to, a DC load 110 may incorporate one or more DC-DC switching converters or the like.

Typically, the AC power source 106 is an AC generator that converts hydro-carbon-based fuel into electricity. The AC power source 106 outputs AC power onto an AC network 118 at a predefined AC voltage. The AC power is output onto an AC power bus 120 at AC current levels which match the current draws of the AC loads 108 and the DC loads 110, 114, plus any system power losses on connectors of the AC network 118.

The plurality of AC devices, generically illustrated as the AC loads 108, are electrically coupled to the AC bus 120 via their respective AC connectors 122. The provided AC power, for reliable operation of the AC loads 108, must be substantially free of harmonic distortion, or must at least provide AC power that satisfies specified harmonic distortion limitations.

The optional AC/DC converter 116 is coupled to the AC bus 120, via connector 124, and draws AC power as needed to source the other DC loads 114. The load (power consumption) of the other DC loads 114 may be relatively constant and at a known value. For example, but not limited to, the other DC loads 114 may include one or more batteries which are charged with the AC/DC converter 116. Accordingly, the AC/DC converter 116 may be specifically designed to provide DC power to the other DC loads 114 without substantially inducing unacceptable levels of undesirable harmonic distortion back onto the AC network 118 since the load drawn by the other DC loads 114 is known and is relatively constant in magnitude. (In alternative embodiments, the other AC loads 114 may be sourced from the mode controlled AC/DC converter 100, and the optional AC/DC converter 116 may then be omitted.)

In practice, it may not be feasible to source the plurality of DC loads 110 from the optional AC/DC converter 116 for a variety of reasons, such as DC connector voltage drops and/or potential harmonic distortion issues. Accordingly, the plurality of DC loads 110 must be sourced from other AC/DC converters.

In view of the weight, cost and/or size benefits of sourcing the plurality of DC loads 110 from a single converter, the plurality of DC loads 110 are sourced from an embodiment of the mode controlled AC/DC converter 100, via connectors 126. At times, the total load drawn from the plurality of DC loads 110 may be relatively low, particularly if one or more of the plurality of DC loads 110 are off (not in operation and therefore not drawing DC power from the mode controlled AC/DC converter 100). Accordingly, the mode controlled AC/DC converter 100 is operated under critical conduction mode (CRM) control so that harmonic distortion is limited to at least the specified harmonic distortion limit.

At other times, the total load drawn from the plurality of DC loads 110 may be relatively high, particularly if all of, or nearly all of, the plurality of DC loads 110 are on (in operation and therefore drawing DC power from the mode controlled AC/DC converter 100). Accordingly, the mode controlled AC/DC converter 100 is operated under continuous conduction mode (CCM) control so that harmonic distortion is limited to at least the specified harmonic distortion limit.

Controlled operation of the plurality of DC loads 110 is managed by the DC load control system 112. The DC load control system 112 may be a single controller, or a plurality of dispersed controllers each controlling particular ones of the DC loads 110. To describe operation of the DC loads 110 under operation of the DC load control system 112, a non-limiting simplified hypothetical example is provided. Assume that the first DC load 110a includes LED-based cabin lights used to light various signs in the cabin of the aircraft 104, such as the fasten seat belt lights, the toilet status lights, or attendant signal lights. When such LED-based lights are on, the total load drawn by this example first DC load 110a is relatively small, and if variable, the variation in DC load is relatively small. These LED-based lights are typically controlled from various locations about the aircraft 104, such as from the pilot cockpit, an attendant station, and/or from passenger seating areas. Such LED-based lights are actuated by a controller, light switch or the like which causes these LED-based lights to be turned on. Here, the controllers, light switches or the like are part of the example DC load control system 112.

Further, assume that the second DC load 110b includes LED-based warning lights used to light various warning lights on the external surface of the aircraft, such as the wing tip warning lights, the tail warning lights, or the like. When such LED-based lights are on, the total load drawn by this example second DC load 110b is relatively small, and typically does not vary while the aircraft 104 is in operation. The LED-based warning lights are typically controlled from the pilot cockpit of the aircraft 104, wherein the pilot actuates a controller, light switch or the like which causes these LED-based warning lights to be turned on. These LED-based warning lights are left on during flight and while the aircraft 104 is moving about the airport. Here, the controllers, light switches or the like are part of the example DC load control system 112.

Further, assume that the N^{th} DC load 110n includes LED-based landing lights used during landing of the aircraft 104. When such LED-based landing lights are on, the total load drawn by this example N^{th} DC load 110n is relatively high because of the luminosity output requirements to provide sufficient light for landing. Further, the amount of DC load drawn by the LED-based landing lights is substantially constant. The LED-based landing lights are typically controlled from the pilot cockpit of the aircraft 104 during landing and/or during take off. The pilot actuates a controller, light switch or the like which causes these LED-based landing lights to be turned on. These LED-based landing lights are left on during landing and/or take off of the aircraft 104. Here, the controller, light switch or the like are part of the example DC load control system 112.

The above-described LED-based lights of the first DC load 110a, the second DC load 110b, through the N^{th} DC load 110n are electrically and/or are communicatively coupled to the DC load control system 112 via connectors 128. Thus, if one of the LED-based lights of the first DC load 110a, the second DC load 110b, and the N^{th} DC load 110n are turned on, a suitable control signal is communicated over the respective one of the connectors 128.

In view of the above-described simplified hypothetical example, when the LED-based lights of the first DC load 110a and/or the second DC load 110b are on, the total DC load sourced by the mode controlled AC/DC converter 100 is relatively small. Accordingly, the mode controlled AC/DC converter 100 is operated under CRM control so that harmonic distortion is limited to at least the specified harmonic distortion limit.

On the other hand, when the LED landing lights of the N^{th} DC load 110n are turned on, the amount of DC power provided by the mode controlled AC/DC converter 100 rapidly increases to a relatively large amount. That is, when the LED landing lights are turned on during landing or takeoff maneuvers, the total DC load sourced by the mode controlled AC/DC converter 100 is relatively high. Accordingly, the mode controlled AC/DC converter 100 is operating under CCM control so that harmonic distortion is limited to at least the specified harmonic distortion limit.

FIG. 2 is a block diagram of an embodiment of a mode controlled AC/DC converter 100. The non-limiting example embodiment of the mode controlled AC/DC converter 100 comprises an AC/DC converter 202, a continuous conduction mode (CCM) controller 204, a critical conduction mode (CRM) controller 206, a controller 208, and an optional filter 210.

The optional filter 210 provides power signal conditioning to the received AC power provided from the AC network 118 via connector 124. The connector 124 is illustrated as a single connector. However, in practice, connector 124 comprises a plurality of connectors that provide one or more phases of AC power from the AC network 118, and may further include a neutral connector. In the various embodiments, any suitable type of AC power signal conditioning circuitry may be used to filter incoming AC power, filter electromagnetic interference, and/or to filter generated harmonics.

During a first mode of operation, the CCM controller 204 is configured to control operation of the AC/DC converter 202 when the total power converted by the AC/DC converter 202 is operating at load levels that are equal to or greater than (at least equal to) a load threshold. This mode of operation is referred to herein as mode 1 (CCM). When the AC/DC converter 202 is operating under mode 1 (CCM) control, relatively low harmonic distortion is generated from the AC/DC converter 202 that is operating under the control of the CCM controller 204. Any injected harmonic distortion from the AC/DC converter 202 is less that or equal to the specified harmonics distortion limitations for the AC loads 108 which are also connected to the AC network 118. During this first mode, boost power factor correction (PFC) with average current control can be implemented using readily available boost PFC average current mode controller integrated circuits (ICs).

During a second mode of operation, the CRM controller 206 is configured to control operation of the AC/DC converter 202 when the total power converted by the AC/DC converter 202 is less than the load threshold. This mode of operation is referred to herein as mode 2 (CRM). When the AC/DC converter 202 is operating under mode 2 (CRM) control, relatively low harmonic distortion is generated from the AC/DC converter 202 than if it were operating under the control of the CCM controller 204 for the same reduced load condition. That is, significant and undesirable levels of harmonic distortion exceeding harmonic distortion limits would result if CCM control is otherwise employed during these reduced load, or light load, conditions. This is attributed to the boost inductor current reaching zero value during the each switching cycle at light loads. During low load conditions that are lower than a threshold load on the AC/DC converter 202, inductor current goes into a discontinuous mode of operation. The discontinuous mode of operation causes incorrect information of average current, which is responsible for increased harmonic distortion which exceeds harmonic distortion limits.

Any injected harmonic distortion from the AC/DC converter 202 is no more than the specified harmonics distortion limitations for the AC loads 108 which are also connected to the AC network 118. When the AC/DC converter 202 is operating under the second mode. During this second mode, boost PFC in critical conduction mode can be implemented using readily available boost PFC transition mode controller ICs.

Mode selection is performed dynamically on a real-time basis, or near real-time basis, during operation of the AC/DC converter 202 in order to achieve low input current harmonic distortion power factor correction for the plurality of DC loads 110. The two modes of operation will cover the entire operational load range of the AC/DC converter 202, with mode 1 selected for high load conditions (above the load threshold), and with mode 2 selected for low load conditions (below the load threshold).

The ideal PFC rectifier can be modeled as Resistor Emulator (Re). In an example embodiment, a MOSFET and a diode can be operated under a loss free resistor model. The effective resistance of the Re is given as:

$${R}_{e} = \frac{{V}_{g}}{{i}_{g}} \qquad ( 1 )$$

In equation (1), “Vg” is the instantaneous AC Voltage applied at input and “ig” is the instantaneous current drawn by the AC/DC converter 202. The resultant model is further simplified as a voltage controlled current source responsible for power transfer to load. Re is obtained from power transferred to the DC loads 110, and can be numerically calculated as:

$${R}_{e} = \frac{{V}_{g}^{2}}{{P}_{o}} \times η \qquad ( 2 )$$

In equation (2), Po is the output power transferred to load and 11 is the efficiency of the AC/DC converter 202. The AC/DC converter 202 operates in the first mode, the CCM mode, if its loading satisfies the following relation.

$${R}_{e} \leq \frac{2 \times L}{{T}_{s} \times ( 1 - \frac{{V}_{g}}{{V}_{o}} )} \qquad ( 3 )$$

In equation (3), Ts is the switching time period and L is the boost inductance. For PFC Boost rectifiers, duty ratio varies from 1 at input zero crossing to a certain minimum value at peak of the line input voltage. The converter will be operating in DCM over entire AC line cycle if the following condition is met:

$${R}_{e} \geq \frac{2 \times L}{{T}_{s}} \qquad ( 4 )$$

Embodiments may make use of the equations (3) and (4) to select between the operating modes. For high power or near rated converter outputs, the CCM condition is satisfied easily. The load information is readily available for the converter and as CCM converters are operated at fixed switching frequency, Ts is also known. Accordingly, controller 208 decides between the two operating modes. Thus, the mode of operation of the AC/DC converter 202 (CCM or DCM) is load dependent, wherein the critical threshold load is definable by the above equations.

In an example embodiment, the controller 208 may be a micro-controller which receives an input signal from the input 212. In other embodiments, the controller 208 is implemented in hardware and is responsive to an input signal from the input 212. In other embodiments, the controller 208 may be implemented as firmware, or a combination of hardware and firmware.

In an example embodiment, the CCM controller 204 and/or the CRM controller 206 may also be a micro-controllers which receive an input signal from the controller 208. In other embodiments, the CCM controller 204 and/or the CRM controller 206 may be implemented in hardware and are responsive to an input signal from the controller 208. In other embodiments, the CCM controller 204 and/or the CRM controller 206 may be implemented as firmware, or a combination of hardware and firmware. Any suitable circuit topology may be used which provide the mode 1 (CCM) and the mode 2 (CRM) of the AC/DC converter 202 using the CCM controller 204 and the CRM controller 206, respectively.

In an example embodiment, load on the AC/DC converter 202 is monitored. The monitored load level is used to generate the control signal from the input 212, which is used by the controller 208 to determine the mode of operation. If control signal from the input 212 indicates that loading on the AC/DC converter 202 has decreased from above the load threshold to below the load threshold for some predefined mode change duration, then the mode of operation of the AC/DC converter 202 changes from mode 1 (CCM) to mode 2 (CRM). Conversely, if the control signal from the input 212 indicates that loading on the AC/DC converter 202 has increased from below the load threshold to above the load threshold for the mode change duration, then the mode of operation of the AC/DC converter 202 changes from mode 2 (CRM) to mode 1 (CCM).

In an example embodiment, the mode change duration is three cycles of the AC power sinusoidal wave. Thus, the loading on the AC/DC converter 202 must transition across the load threshold, and then remain over/below the load threshold for at least the mode change duration. If the power changes back before expiration of the mode change duration, the mode of operation of the AC/DC converter 202 is not changed.

Any suitable mode change duration may be used. In an example embodiment, the mode change duration is a predefined time of 5 milliseconds. The requirement of the predefined mode change duration is to prevent oscillatory mode switching, where the mode operation repeatedly alternates between mode 1 (CCM) and mode 2 (CRM). This rapid and repeating (oscillatory) operation mode changing may be referred to as hunting or the like.

In some embodiments, two different mode change durations are used. A first mode change duration is in effect for transitions from mode 1 (CCM) to mode 2 (CRM). A second mode change duration is in effect for transitions from mode 2 (CRM) to mode 1 (CCM).

During an operation mode change, from mode 1 (CCM) to mode 2 (CRM), and/or from mode 2 (CRM) to mode 1 (CCM), an example embodiment may perform a soft disabling of the initially operating one of the CCM controller 204 or the CRM controller 206. The soft disabling is performed for a blanking period to enable the next operating one of the controllers 204, 206. During the blanking period, neither of the CCM controller 204 or the CRM controller 206 will be controlling the AC/DC converter 202. Accordingly, the AC/DC converter 202 will not be converting AC power from the AC network 118.

For example, if the AC/DC converter 202 is initially operating under mode 1 (CCM) control, and the DC load information indicates that the DC loading has dropped below the load threshold, then CCM control is stopped. During the blanking duration, a hold-up capacitor supplies power to the load without appreciable drop of voltage at its terminals. Then, CRM control begins after a conclusion of the blanking period.

The blanking period is selected to be lower than a hold-up time (discharge time) of an output bulk capacitor of the AC/DC converter 202. Accordingly, output of the AC/DC converter 202 is maintained by discharge of the capacitor during the blanking duration of the mode change.

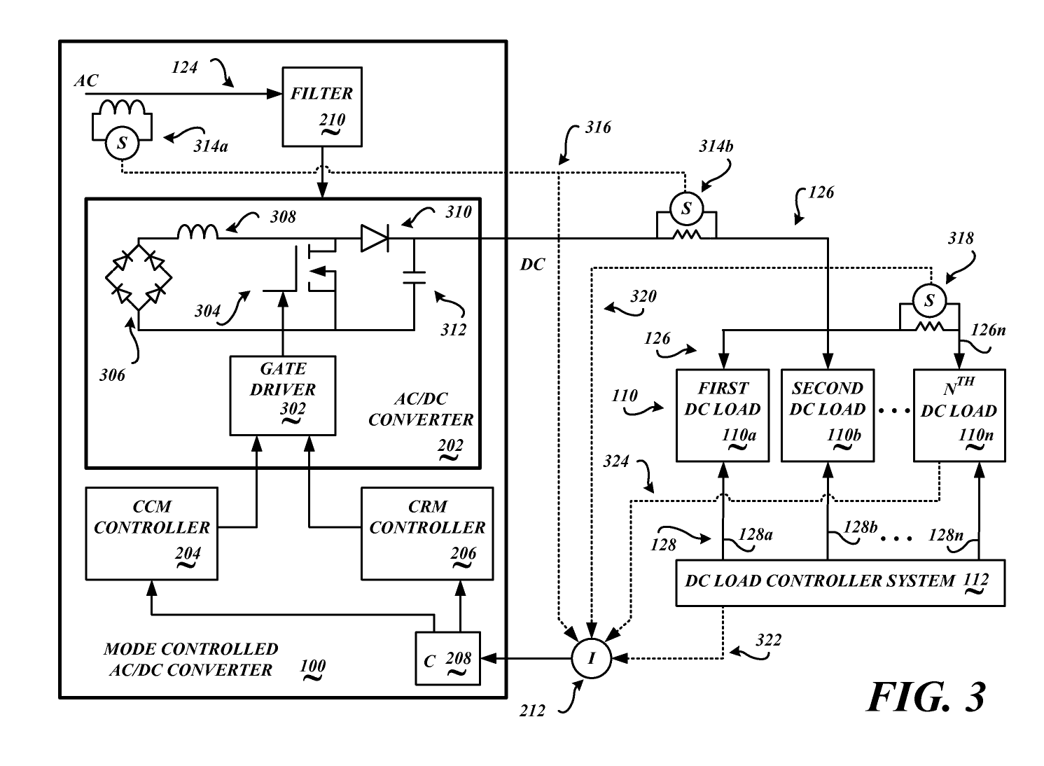

FIG. 3 is a block diagram of an exemplary embodiment of the mode controlled AC/DC converter 100. The exemplary embodiment of the AC/DC converter 202 comprises a gate driver 302, a gate 304, a diode bridge 306, an inductor 308, a diode 310, and a capacitor 312. Other components (not shown) may be included in alternative embodiments.

The diode bridge 306 receives conditioned AC power from the filter 210. The example diode bridge 306 rectifies the received AC current into DC current. In alternative embodiments, a plurality of diode bridges 306 may be used depending upon the number of AC phases used to receive AC power from the AC network 118. Any suitable rectifying circuit topology may be used which rectifies received AC power, AC current, and/or AC voltage into corresponding DC power, DC current, and/or DC voltage. Embodiments may use full wave rectification.

The inductor 308 conditions the DC power, DC current, and/or DC voltage output from the example diode bridge 306. Embodiments may optionally employ any suitable circuit topology to condition the DC power, DC current, and/or DC voltage.

The gate driver 302 is configured to receive control signals from the CCM controller 204 or the CRM controller 206. The gate driver 302 outputs a control signal that is configured to operate the control terminal of a power semiconductor switch 304. Any suitable circuit topology may be for the gate driver 302. The gate driver 302 may be implemented as hardware, and the logic for switching can be implemented in firmware, or a combination of hardware and firmware.

The gate 304 is operated in accordance with control signals received from the gate driver 302. Accordingly, the DC loading level is controllable by providing control signals to the gate driver 302, which then controls the gate 304. Embodiments may use any suitable solid state device that is configured to regulate the DC power, DC current, and/or DC voltage output from the AC/DC converter 202. In some embodiments, multiple gates 304 may be cooperatively operated, under the control of one or more gate drivers 302, to regulate the output DC power, DC current, and/or DC voltage.

The 310 manages flow of the output DC current, and prevents undesirable DC current from flowing in a reverse direction (opposite to the direction of DC current flow that is sourcing the plurality of DC loads 110). In some embodiments, other circuitry may be employed to manage flow of the DC current to the DC loads 110.

As noted herein, the input 212 provides a signal to the controller 208 so that the controller 208 may determine the mode of operation of the AC/DC converter 202. Information provided by the input 212 is used by the controller 208 to determine if the magnitude of the DC loads 110 is greater than or equal to the load threshold, or if the magnitude of the DC Loads 110 is less than the load threshold. Accordingly, the controller 208 compares the determined magnitude of the DC loads 110 with the load threshold.

When the magnitude of the DC loads 110 is greater than or equal to the load threshold, the mode controlled AC/DC converter 100 is operated in mode 1 (CCM). During mode 1 operation, the controller 208 outputs a control signal that operates the CCM controller 204. The CCM controller 204 outputs a control signal to the gate driver 302 so that the gate 304 is driven in accordance with the control signals from the CCM controller 204. Accordingly, the AC/DC converter 202 is operated using CCM control.

Concurrently during mode 1 (CCM) operation, a null control signal or a disable control signal is provided by the controller 208 to the CRM controller 206 so that the CRM controller 206 is inoperative. That is, the CRM controller 206 is not providing a control signal to the gate driver 302.

When the magnitude of the DC loads 110 is less than the load threshold, the mode controlled AC/DC converter 100 is operated in mode 2 (CRM). During mode 2 operation, the controller 208 outputs a control signal that operates the CRM controller 206. The CRM controller 206 outputs a control signal to the gate driver 302 so that the gate 304 is driven in accordance with the control signals from the CRM controller 206. Accordingly, the AC/DC converter 202 is operated using CRM control.

Concurrently during mode 2 (CRM) operation, a null control signal or a disable control signal is provided by the controller 208 to the CCM controller 204 so that the CCM controller 204 is inoperative. That is, the CCM controller 204 is not providing a control signal to the gate driver 302.

In some embodiments, the controller 208, the CCM controller 204, the CRM controller 206, and/or the gate driver 302 are integrated together into a single device, such as in integrated chip (IC) or the like. Such an integrated device be implemented as firmware, or a combination of hardware and firmware.

In the various embodiments, soft disabling may be optionally performed for a blanking period to enable the next operating one of the controllers 204, 206. During the blanking period, neither of the CCM controller 204 or the CRM controller 206 will be controlling the AC/DC converter 202. Accordingly, the AC/DC converter 202 will not be converting AC power from the AC network 118. However, DC power drawn by the DC loads 110 must be maintained during the blanking period because it is undesirable for the DC loads 110 to become inoperable during the blanking period. Accordingly, embodiments of the mode controlled AC/DC converter 100 include the capacitor 312.

When the mode controlled AC/DC converter 100 is operating in either mode 1 (CCM) or mode 2 (CRM), DC current charges the capacitor 312. Accordingly, the capacitor 312 discharges its absorbed power as DC current during the blanking period. The voltage and the capacity of the capacitor 312 may be determined based on the greatest DC load that is drawn by the mode controlled AC/DC converter 100 when all of (or most of) the DC loads 110 are operating. That is, once the maximum DC load is determined, the rating of the capacitor may be determined based on the maximum DC load and the duration of the blanking period. Here, the discharge time constant of the capacitor 312 during maximum DC loading is used to determine the appropriate size of the capacitor 312 such that adequate DC voltage and current are maintained during the blanking period.

The input received by the controller 208 (used to determine DC loading and the associated comparison with the load threshold) may be provided in a variety of forms, generally indicated as the control signal from the input 212. In a first embodiment, a signal corresponding to the real-time loading level of the plurality of DC loads 110 is provided to the controller 208.

An example AC sensor circuit 314a may be used to sense AC current drawn by the mode controlled AC/DC converter 100 from the AC network 118. Any suitable AC sensor circuit 314a may be used by the various embodiments. The AC sensor circuit 314a may sense single phase, two phase, or three phase AC current on the connector 124. The magnitude of the sensed AC current corresponds to the magnitude of the AC power drawn by the mode controlled AC/DC converter 100. Some AC sensor circuits 314a may sense AC voltage and/or AC power factor. The sensed AC current, AC voltage, and/or AC power factor may be used to provide an accurate and reliable determination of the amount of AC power drawn by the mode controlled AC/DC converter 100.

Alternatively, a DC sensor circuit 314b may be used to sense the real-time loading level of the plurality of DC loads 110. The DC sensor circuit 314b may be configured to sense DC current on the portion of the connector 126 that is coupled to, or is proximate to, the AC/DC converter 202.

For example, but not limited to, if the AC sensor circuit 314a is sensing total AC current drawn by the controlled AC/DC converter 100, a control signal proportional to, or corresponding to, the sensed AC current may be output from the AC sensor circuit 314. Alternatively, if the DC sensor circuit 314b is sensing total DC current output from the controlled AC/DC converter 100, a control signal proportional to, or corresponding to, the sensed DC current may be output from the DC sensor circuit 314b. The control signal output from the AC sensor circuit 314a or the DC sensor circuit 314b is then communicated to the controller 208, via connection 316. Alternatively, the control signal output from the AC sensor circuit 314a or the DC sensor circuit 314b may be wirelessly communicated to the controller 208 using a suitable radio frequency (RF) signal using suitable RF transceivers in the AC sensor circuit 314a and the controller 208.

The received control signal output from the AC sensor circuit 314a or the DC sensor circuit 314b corresponding to the real-time sensed AC current or DC current, respectively, is then compared with the current threshold (here, generically referred to as the load threshold). If the sensed AC or DC current is greater than or equal to (at least equal to) the current threshold, then the mode controlled AC/DC converter 100 is operated under mode 1 (CCM) control. Conversely, if the sensed AC or the DC current is less than the current threshold, then the mode controlled AC/DC converter 100 is operated under mode 2 (CRM) control.

In some embodiments, some of the individual ones of the DC loads 110 may be sufficiently large such that if one or more of these relatively large DC loads are on (are operating), then the mode controlled AC/DC converter 100 can be assumed to be loaded to a level that is greater than or equal to the load threshold. Accordingly, the mode controlled AC/DC converter 100 should be operated under mode 1 (CCM) control. When such relatively large DC loads are off (not operating), then the mode controlled AC/DC converter 100 can be assumed to be loaded to a level that is less than the load threshold. Here, even if one or more of the other relatively small DC loads are on, the mode controlled AC/DC converter 100 should be operated under mode 2 (CRM) control.

Returning to the above-described aircraft example, the DC loads 110 may include at least the LED-based cabin lights (the first DC load 110a), the LED-based warning lights on the external surface of the aircraft 104 (the second DC load 110b) and LED-based landing lights (the N^{th} DC load 110n). Assume that the total DC load drawn by the LED-based cabin lights and the LED-based warning lights, when all such LED-based lights are on, is less than the load threshold. Further assume that the DC load drawn by the LED-based landing when on is greater than the load threshold. That is, even if the LED-based cabin lights and the LED-based warning lights are off while the LED-based landing lights are on, the total DC load drawn by the mode controlled AC/DC converter 100 is greater than the load threshold.

Accordingly, if the LED-based landing lights are on, the mode controlled AC/DC converter 100 should be operated in mode 1 (CCM). If the LED-based landing lights are off (even if the LED-based cabin lights and the LED-based warning lights are on), the mode controlled AC/DC converter 100 should be operated in mode 2 (CRM). Accordingly, embodiments of the mode controlled AC/DC converter 100 need only sense or determine if the LED-based landing lights are on to determine the appropriate operating mode (CCM or CRM).

In systems with DC loads as described above, an example embodiment of the mode controlled AC/DC converter 100 includes a DC sensor circuit 318. The DC sensor circuit 318 outputs a signal indicating the operating status of the LED-based landing lights.

An example DC sensor circuit 318 senses DC current drawn by the LED-based landing lights. Any suitable DC sensor circuit 318 may be used by the various embodiments. If DC current is sensed by the DC sensor circuit 318, the LED-based landing lights are on. If no DC current is sensed by the DC sensor circuit 318, the LED-based landing lights are off. For example, a first value of the control signal (a high voltage or a logical 1) from the DC sensor circuit 318 may indicate that the LED-based landing lights are on, and a second value of the control signal (a low voltage or a logical 0) may indicate that the LED-based landing lights are off.

The control signal output from the DC sensor circuit 318 is then communicated to the controller 208, via connection 320. Alternatively, the control signal output from the DC sensor circuit 318 may be wirelessly communicated to the controller 208 using a suitable radio frequency (RF) signal using suitable RF transceivers in the DC sensor circuit 318 and the controller 208.

The state or logical value of the received control signal output from the DC sensor circuit 318 is then compared with a logical threshold (here, generically referred to as the load threshold). If the comparison of the control signal output from the DC sensor circuit 318 and the logical threshold indicates that the LED-based landing lights are on, then the mode controlled AC/DC converter 100 is operated under mode 1 (CCM) control. Conversely, if the comparison of the control signal output from the DC sensor circuit 318 and the logical threshold indicates that the LED-based landing lights are off, then the mode controlled AC/DC converter 100 is operated under mode 2 (CRM) control. In an example embodiment, the logical threshold is a high voltage or a logical one. Alternatively, the logical threshold may be a low voltage or a logical 0.

In another embodiment, with DC loads as described above, an example embodiment of the mode controlled AC/DC converter 100 receives a DC load status signal directly from the DC load controller system 112. For example, the crew of the aircraft 104 may actuate a switch or the like to turn on the LED-based landing lights during a landing maneuver. The DC load controller system 112 outputs a signal indicating the operating status of the LED-based landing lights that is provided to the controller 208. For example, status of the switch (on or off) controlling the LED-based landing lights may be detected. Alternatively, status of a control signal on connector 128n may be monitored. If a first status is indicated by the DC load controller system 112, the LED-based landing lights are on. For example, a first value of the control signal (a high voltage or a logical 1) from the DC load controller system 112 may indicate that the LED-based landing lights are on, and a second value of the control signal (a low voltage or a logical 0) may indicate that the LED-based landing lights are off.

The control signal output from the DC load controller system 112 is then communicated to the controller 208, via connection 322. Alternatively, the control signal output from the DC load controller system 112 may be wirelessly communicated to the controller 208 using a suitable radio frequency (RF) signal using suitable RF transceivers in the DC load controller system 112 and the controller 208.

The state or logical value of the received control signal output from the DC load controller system 112 is then compared with a logical threshold (here, generically referred to as the load threshold). If a comparison of the control signal output from the DC load controller system 112 and the status threshold indicates that the LED-based landing lights are on, then the mode controlled AC/DC converter 100 is operated under mode 1 (CCM) control. Conversely, if the comparison of the control signal output from the DC load controller system 112 and the logical threshold indicates that the LED-based landing lights are off, then the mode controlled AC/DC converter 100 is operated under mode 2 (CRM) control.

Alternatively, a sensor (not shown) may be located at, or incorporated as part of, the LED-based landing lights (the N^{th} DC load 110n). Here, a control signal is communicated from the LED-based landing lights to the controller 208. Any suitable sensor or the like may be included at the LED-based landing lights. The received control signal output from the LED-based landing lights is then compared with a status threshold or the like (here, generically referred to as the load threshold). If a comparison of the control signal output from the LED-based landing lights and the status threshold indicates that the LED-based landing lights are on, then the mode controlled AC/DC converter 100 is operated under mode 1 (CCM) control. Conversely, if the comparison of the control signal output from the LED-based landing lights and the status threshold indicates that the LED-based landing lights are off, then the mode controlled AC/DC converter 100 is operated under mode 2 (CRM) control.

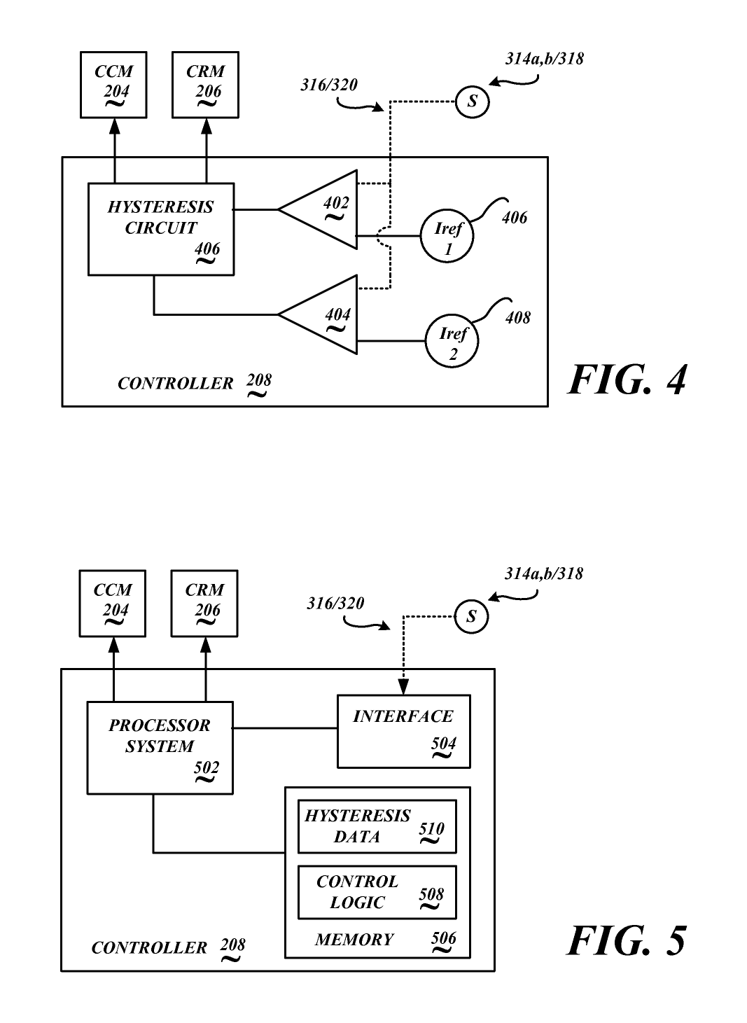

FIG. 4 is a block diagram of a non-limiting firmware embodiment of the controller 208 that provides hysteresis control. Alternative firmware, or combination firmware and hardware, or hardware embodiments may employ other suitable circuit topologies that provide hysteresis control.

The example controller 208 is configured to implement hysteresis control of the CCM controller 204 and the CRM controller 206. The example controller 208 comprises a first comparator 402, a second comparator 404, and a hysteresis control circuit 406.

The first comparator 402 compares sensed loading information provided by one of the sensors 314a, 314b, or 318 with a first reference current (Iref 1), here, generically referred to as a first load threshold, provided by a first reference current source 406. The first comparator 402 outputs a first comparator signal in a first state when the DC load information is at least equal to the first reference current. The first comparator 402 outputs the first comparator signal in a second state when the DC load information is less than the first reference current.

The second comparator 404 compares sensed loading information provided by one of the sensors 314a, 314b, or 318 with a second reference current (Iref 2), here, generically referred to as a second load threshold, provided by a second reference current source 408. The second comparator 404 outputs a second comparator signal in a first state when the DC load information is at least equal to the second reference current. The second comparator 404 outputs the second comparator signal in a second state when the DC load information is less than the second reference current.

Any suitable device or circuit may be used to generate the first reference current and the second reference current. The first reference current and the second reference current provide inputs to the hysteresis control circuit 406, which then provides control signals to the CCM controller 204 and the CRM controller 206.

The first reference current and the second reference current differ by some predefined amount, wherein the first reference current is greater than the second reference current. Accordingly, the first reference current and the second reference current cooperatively act as references for a hysteresis control scheme.

When the sensed loading information is greater than the first reference current and the second reference current, then the outputs of the first comparator 402 and the second comparator 404 are at a first state such that the hysteresis control circuit 406 provides a control signal that enables the CCM controller 204 to operate the mode controlled AC/DC converter 100 in the mode 1 (CCM) operation.

When the sensed loading information is less than the first reference current and the second reference current, then the outputs of the first comparator 402 and the second comparator 404 are at a second state such that the hysteresis control circuit 406 provides a control signal that enables the CRM controller 206 to operate the mode controlled AC/DC converter 100 in the mode 2 (CRM) operation.

When the sensed loading information is decreasing, while in mode 1 (CCM) operation, and becomes less than the first reference current while still being greater than the second reference current, then the output of the first comparator 402 changes to the second state while the second comparator 404 remains in the first state. When the first comparator 402 and the second comparator 404 are in these states, the hysteresis control circuit 406 provides a control signal that continues to enable the CCM controller 204 to operate the mode controlled AC/DC converter 100 in the mode 1 (CCM) operation.

When the sensed load later decreases below the second reference current, the second comparator 404 then changes to second state such that the hysteresis control circuit 406 provides a control signal that enables the CRM controller 206 to operate the mode controlled AC/DC converter 100 in the mode 2 (CRM) operation. That is, in response to the DC load information initially being greater than the first load threshold, changing operation of the AC/DC converter 202 from the CCM control to the CRM control in response DC load information decreasing to a value that is less than the second load threshold.

Conversely, when the sensed loading information is increasing, while in mode 2 (CRM) operation, and becomes greater than the second reference current while still being less than the first reference current, then the output of the second comparator 404 changes to the first state while the first comparator 402 remains in the second state. When the first comparator 402 and the second comparator 404 are in these states, the hysteresis control circuit 406 provides a control signal that continues to enable the CRM controller 206 to operate the mode controlled AC/DC converter 100 in the mode 2 (CRM) operation.

When the sensed load later increases above the first reference current, the first comparator 402 then changes to first state such that the hysteresis control circuit 406 provides a control signal that enables the CCM controller 204 to operate the mode controlled AC/DC converter 100 in the mode 1 (CCM) operation. That is, in response to the DC load information initially being less than the first load threshold, changing operation of the AC/DC converter 202 from the CRM control to the CCM control in response DC load information increasing to a value that is at least equal to the first load threshold.

FIG. 5 is a block diagram of a non-limiting software embodiment of the controller 208 that provides hysteresis control. The controller 208 comprises a processor system 502, an interface 504, and a memory 506. The memory 506 comprises portions for storing the control logic 508 and the hysteresis data 510. Processor system 502 controls the execution of the control logic 508, wherein embodiments of the mode controlled AC/DC converter 100 are able to operate under mode 1 (CCM) or mode 2 (CRM) control using hysteresis. It is understood that any suitable processor system 502 may be employed in various embodiments of a digital clay device. The processor system 502 may be a specially designed and/or fabricated processing system, or may be a commercially available processor system.

The interface receives the sensed loading information provided by one of the sensors 314a, 314b, or 318. The interface 504 converts the information into a suitable format that may be processed by the processor system 502. The converted loading information is communicated from the interface 504 to the processor system 502 on a real-time, or near real-time basis.

In an example embodiment, a first hysteresis value (here, generically referred to as a first load threshold), is stored in the hysteresis data 510. A second hysteresis value (here, generically referred to as a second load threshold) is also stored in the hysteresis data 510. The first and the second hysteresis values may be a current value, a load value or the like. The first hysteresis value and the second hysteresis value differ by some predefined amount, wherein the first hysteresis value is greater than the second hysteresis value. Accordingly, the first hysteresis value and the second hysteresis value cooperatively act as references for a hysteresis control scheme.

The processor system 502, executing the control logic 508, compares sensed loading information provided by the interface 504 with the first hysteresis value and the second hysteresis value retrieved from the memory 506. When the sensed loading information is greater than the first and the second hysteresis values, the processor system 502 provides a control signal that enables the CCM controller 204 to operate the mode controlled AC/DC converter 100 in the mode 1 (CCM) operation. When the sensed loading information is less than the first and the second hysteresis values, the processor system 502 provides a control signal that enables the CRM controller 206 to operate the mode controlled AC/DC converter 100 in the mode 2 (CRM) operation.

When the sensed loading information is decreasing, while in mode 1 (CCM) operation, and becomes less than the first hysteresis value while still being greater than the second hysteresis value, the processor system 502 provides a control signal that continues to enable the CCM controller 204 to operate the mode controlled AC/DC converter 100 in the mode 1 (CCM) operation. When the sensed load later decreases below the second hysteresis value, the processor system 502 then provides a control signal that enables the CRM controller 206 to operate the mode controlled AC/DC converter 100 in the mode 2 (CRM) operation. That is, in response to the DC load information initially being greater than the first load threshold, changing operation of the AC/DC converter 202 from the CCM control to the CRM control in response DC load information decreasing to a value that is less than the second load threshold.

Conversely, when the sensed loading information is increasing, while in mode 2 (CRM) operation, and becomes greater than the second hysteresis value while still being less than the first hysteresis value, the processor system 502 provides a control signal that continues to enable the CRM controller 206 to operate the mode controlled AC/DC converter 100 in the mode 2 (CRM) operation. When the sensed load later increases above the first hysteresis value, the processor system 502 then provides a control signal that enables the CCM controller 204 to operate the mode controlled AC/DC converter 100 in the mode 1 (CCM) operation. That is, in response to the DC load information initially being less than the first load threshold, changing operation of the AC/DC converter 202 from the CRM control to the CCM control in response DC load information increasing to a value that is at least equal to the first load threshold

While the preferred embodiments of the mode controlled AC/DC converter 100 have been illustrated and described, as noted above, many changes can be made without departing from the spirit and scope of the invention. Accordingly, embodiments of the mode controlled AC/DC converter 100 are not limited by the disclosure of the preferred embodiment. Instead, the invention should be determined entirely by reference to the claims that follow.

The embodiments of the invention in which an exclusive property or privilege is claimed are defined as follows:

1. A method, comprising:
receiving direct current (DC) load information corresponding to a DC load drawn from an alternating current (AC) network by an AC/DC converter, wherein the AC network also sources a plurality of AC loads, and wherein harmonics output from the AC/DC converter is limited to at least a specified harmonic distortion limit;
comparing the DC load information with a load threshold;
in response to the DC load information being at least equal to the load threshold, operating the AC/DC converter under continuous conduction mode (CCM) control; and
in response to the DC load information being less than the load threshold, operating the AC/DC converter under critical conduction mode (CRM) control.

2. The method of claim 1, wherein the load threshold comprises a first load threshold and a second load threshold that is less than the first load threshold, and wherein operating the AC/DC converter comprises:
changing operation of the AC/DC converter from the CCM control to the CRM control in response in response to the DC load information decreasing from an initial value being greater than the first load threshold to a new value that is less than the second load threshold; and
changing operation of the AC/DC converter from the CRM control to the CCM control in response to the DC load information increasing from the initial value being less than the second load threshold to the new value that is greater than the first load threshold.

3. The method of claim 2, wherein the first load threshold corresponds to a first reference current, wherein the second load threshold corresponds to a second reference current, wherein comparing the DC load information with the load threshold further comprises:
providing the first reference current and the DC load information to a first comparator, wherein the AC/DC converter is operated under CCM control in response to the DC load information being greater than the first reference current; and
providing the second reference current and the DC load information to a second comparator, wherein the AC/DC converter is operated under critical CRM control in response to the DC load information being less than the second reference current.

4. The method of claim 3, wherein:
changing operation of the AC/DC converter from the CCM control to the CRM control in response DC load information decreasing from an initial value that is greater than the first reference current to a new value that is less than the second reference current; and
changing operation of the AC/DC converter from the CRM control to the CCM control in response DC load information increasing from the initial value being less than the second reference current to the new value that is greater than the first reference current.

5. The method of claim 1, wherein the DC load information initially corresponds to an initial DC load value that is initially greater than the load threshold such that the AC/DC converter is initially operated under CCM control, the method further comprising:
changing operation of the AC/DC converter from the CCM control to the CRM control in response to the DC load information decreasing to a new DC load value that is less than the load threshold.

6. The method of claim 5, wherein changing operation of the AC/DC converter from the CCM control to the CRM control comprises:
stopping CCM control of the AC/DC converter in response to the new DC load value decreasing to the load threshold;
discharging a capacitor during a blanking duration; and
beginning CRM control of the AC/DC converter after a conclusion of the blanking period.

7. The method of claim 1, wherein the DC load information initially corresponds to an initial DC load value that is initially less than the load threshold such that the AC/DC converter is initially operated under CRM control, the method further comprising:
changing operation of the AC/DC converter from the CRM control to the CCM control in response to the DC load information increasing to a new DC load value that is at least equal to the load threshold.

8. The method of claim 7, wherein changing operation of the AC/DC converter from the CRM control to the CCM control comprises:
stopping CRM control of the AC/DC converter in response to the new DC load value increasing to at least equal the load threshold;
discharging a capacitor during a blanking duration; and
beginning CCM control of the AC/DC converter after a conclusion of the blanking period.

9. The method of claim 1, further comprising:
sensing AC current drawn by the AC/DC converter with a sensor; and
communicating DC load information corresponding to the sensed AC current from the sensor, wherein the DC load information corresponds to at least the DC load drawn from the alternating current AC network by the AC/DC converter.

10. The method of claim 1, further comprising:
sensing DC current output by the AC/DC converter with a sensor; and
communicating DC load information corresponding to the sensed DC current from the sensor.

11. The method of claim 1, further comprising:
sensing operation of a DC load;
communicating first DC load information when the sensed DC load is operational, wherein the AC/DC converter is operated under CCM control when the received DC load information is the first DC load information; and
communicating second DC load information when the sensed DC load is not operational, wherein the AC/DC converter is operated under CRM control when the received DC load information is the second DC load information.

12. A control system, comprising:
an alternating current to direct current (AC/DC) converter configured to convert alternating current (AC) power received from an AC network into direct current (DC) power that is provided to a plurality of DC loads; and
a continuous conduction mode (CCM) controller controllably coupled to the AC/DC converter and configured to control operation of the AC/DC converter during a first mode of operation;
a critical conduction mode (CRM) controller controllably coupled to the AC/DC converter and configured to control operation of the AC/DC converter during a second mode of operation; and
a controller controllably coupled to the CCM controller and the CRM controller, and configured to receive DC load information corresponding to DC load drawn by the AC/DC converter from the AC network,
wherein in response to the DC load being at least equal to a load threshold, the controller communicates a first control signal that enables the CCM controller to control operation of the AC/DC converter, and
wherein in response to the DC load being less than the load threshold, the controller communicates a second control signal that enables the CRM controller to control operation of the AC/DC converter.

13. The control system of claim 12, further comprising:
a sensor communicatively coupled to the controller and configured to sense AC current drawn by the AC/DC converter, and configured to output the DC load information corresponding to an amount of the sensed AC current,
wherein the sensor communicates the DC load information to the controller.

14. The control system of claim 13, further comprising:
a first comparator configured to receive the DC load information, and configured to compare the received DC load information with a first reference current, wherein the first comparator outputs a first comparator signal in a first state when the DC load information is at least equal to the first reference current, and wherein the first comparator outputs the first comparator signal in a second state when the DC load information is less than the first reference current; and
a second comparator configured to receive the DC load information, and configured to compare the received DC load information with a second reference current that is less than the first reference current, wherein the second comparator outputs a second comparator signal in a first state when the DC load information is at least equal to the second reference current, and wherein the second comparator outputs the second comparator signal in a second state when the DC load information is less than the second reference current,
wherein the AC/DC converter is operated under CCM control when first comparator signal of the first comparator is in the first state, and
wherein the AC/DC converter is operated under CRM control when second comparator signal of the second comparator is in the second state.

15. The control system of claim 14,
wherein in response to the first comparator signal of the first comparator changing from the first state to the second state while the second comparator signal remains in the first state, the AC/DC converter continues operation under the CCM control, and
wherein after the first comparator signal of the first comparator has changed to the second state and wherein response to second comparator signal of the second comparator changing from the first state to the second state, the AC/DC converter changes operation to the CRM control.

16. The control system of claim 14,
wherein in response to the second comparator signal of the second comparator changing from the second state to the first state while the first comparator signal remains in the second state, the AC/DC converter continues operation under the CRM control, and
wherein after the second comparator signal of the first comparator has changed to the first state and wherein response to first comparator signal of the first comparator changing from the second state to the first state, the AC/DC converter changes operation to the CCM control.

17. The control system of claim 12, wherein the controller comprises:
a sensor communicatively coupled to the controller and configured to sense DC current output by the AC/DC converter, and configured to output the DC load information corresponding to an amount of the sensed DC current,
wherein the sensor communicates the DC load information to the controller

18. The control system of claim 12, further comprising:
a sensor communicatively coupled to the controller and configured to sense DC current drawn by a selected one of the plurality of DC loads, and configured to output the DC load information in a first state when the selected DC load is operating, and configured to output the DC load information in a second state when the DC load in not operating,
wherein the sensor communicates the DC load information to the controller,
wherein the AC/DC converter is operated in the first mode of operation when the DC load information is in the first state, and
wherein the AC/DC converter is operated in the second mode of operation when the DC load information is in the second state.
